(19) United States
(12) Patent Application Publication
(10) Pub. No.: US 2025/0162458 A1
(43) Pub. Date: May 22, 2025

(54) VEHICLE SYSTEM

(71) Applicant: GM Global Technology Operations LLC, Detroit, MI (US)

(72) Inventors: Matthew Edward Gilbert-Eyres, Rochester Hills, MI (US); Ryan Patrick Hickey, Austin, TX (US); Russell A. Patenaude, Macomb Township, MI (US); Luke John Popiel, Oxford, MI (US)

(73) Assignee: GM Global Technology Operations LLC, Detroit, MI (US)

(21) Appl. No.: 18/515,696

(22) Filed: Nov. 21, 2023

(51) Int. Cl. B60L 58/24; B60L 58/12; G07C 5/00; G07C 5/08

(52) U.S. Cl. CPC B60L 58/24; B60L 58/12; G07C 5/008; G07C 5/0808; G07C 5/0816; G07C 5/085; B60L 2240/622

(57) ABSTRACT

A vehicle system includes a vehicle processor for storing data including vehicle location and vehicle data. The vehicle system also includes a server communicatively coupled to the vehicle processor. The server is configured to determine when the vehicle is being stored based on vehicle location and vehicle data and activate a storage mode when it is determined that the vehicle is being stored.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a vehicle system configured to comply with state-of-charge limitations.

Many vehicles are now electric vehicles powered using batteries. Batteries, particularly fully charged batteries, may pose a fire risk under certain conditions. Accordingly, electric vehicles being transported or stored are often maintained at a charge below a maximum charge and, ideally, within a safety charging capacity window to mitigate any fire risks. The safety charging capacity window is often below the maximum charge but above zero charge, as additional risks to the vehicle can occur if vehicle battery life is at or near zero.

Some transport vehicles now require state-of-charge limitations to help mitigate the risks associated with transporting electric vehicles. While some vehicles include a mode that limits charging to a certain percentage after leaving the manufacturing plant, once the vehicle arrives at its destination such as a dealership, the charging limitation is removed. Accordingly, a need remains to safely and easily store and/or transport a vehicle while complying with state-of-charge limitations.

### SUMMARY

In one configuration, a vehicle system includes a vehicle processor for storing vehicle data including vehicle location and vehicle event data. The vehicle system also includes a server communicatively coupled to the vehicle processor. The server is configured to determine when the vehicle is being stored based on vehicle location and vehicle event data and activate a storage mode when it is determined that the vehicle is being stored.

The vehicle system may include one or more of the following optional features. For example, the server may be configured to notify a user of storage mode being activated. Additionally, the server may be configured to monitor vehicle battery life during storage mode. The server may also be configured to notify a user of low vehicle battery life during storage mode. Additionally, the server may be configured to check for post storage mode tasks that might need to be done prior to driving. Moreover, the server may be configured to notify a user of post storage mode tasks. Additionally, a vehicle may incorporate the vehicle system.

In another configuration, a vehicle system includes a vehicle processor for storing data including vehicle location and vehicle data. The vehicle system also includes a server communicatively coupled to the vehicle processor. The server is configured to determine when the vehicle is being transported based on vehicle location and vehicle event data and activate a transport mode when it is determined that the vehicle is being transported.

The vehicle system may also include one or more of the following optional features. For example, the vehicle location may include Global Positioning System (GPS) location and route information. The server may also be configured to notify a user if it is determined that the vehicle is being transported. Additionally, the server may be configured to monitor vehicle battery life during transport mode. The server may also be configured to notify a user of low vehicle battery life during transport mode. Additionally, the server may be configured to pre-condition a temperature of a vehicle battery to allow for faster charging after transport mode has completed. Moreover, a vehicle may incorporate the vehicle system.

In another configuration, a vehicle system includes a vehicle processor for storing data including vehicle location, vehicle data, and transport length. Additionally, the vehicle system includes a server communicatively coupled to the vehicle processor. The server is communicatively coupled to the vehicle processor and configured to start battery depletion activities based on the vehicle location, the vehicle event data, and the transport length. The battery depletion activities include one or more of enabling max accessory loads including one or more of a chiller operation increase, an increase in coolant flow rate, additional vehicle imaging, activating vehicle sensors to a high-load mode, activating discharge of cell groups by activating cell balancing resistors, and activating inefficient operation of vehicle components including one or more of a vehicle engine or vehicle inverter. The server is also configured to determine which battery depleting activities to activate based on the vehicle location, the vehicle event data, and the transport length.

The vehicle system also includes one or more of the following optional features. For example, the vehicle location may include GPS location and route information. Additionally, the server may be configured to notify a user if it is determined that the vehicle is being transported. The server may also be configured to monitor vehicle battery life during transport mode. Additionally, the server may be configured to pre-condition a temperature of a vehicle battery to allow for faster charging after transport mode has completed. Moreover, a vehicle may incorporate the vehicle system.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle incorporating a vehicle system according to one aspect of the present disclosure; and

FIG. 2 is an exemplary operational flow chart according to one aspect of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

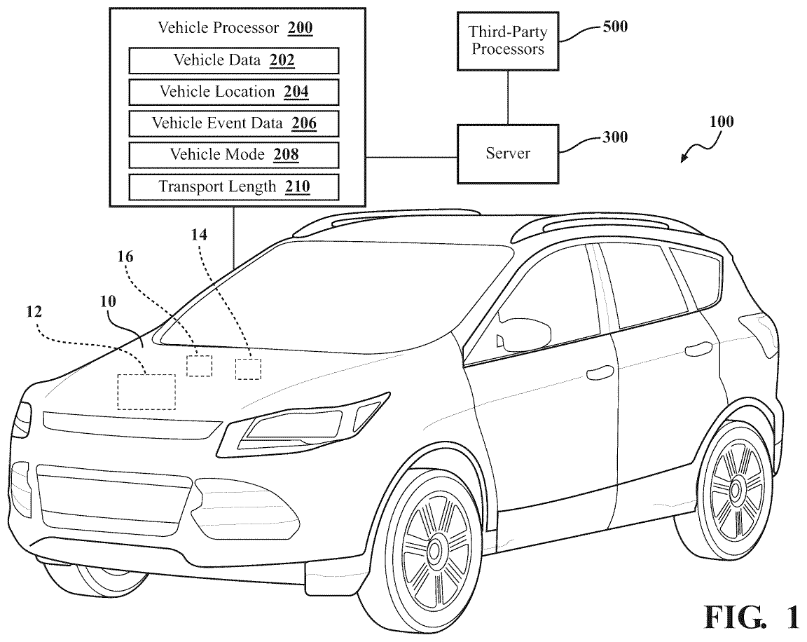

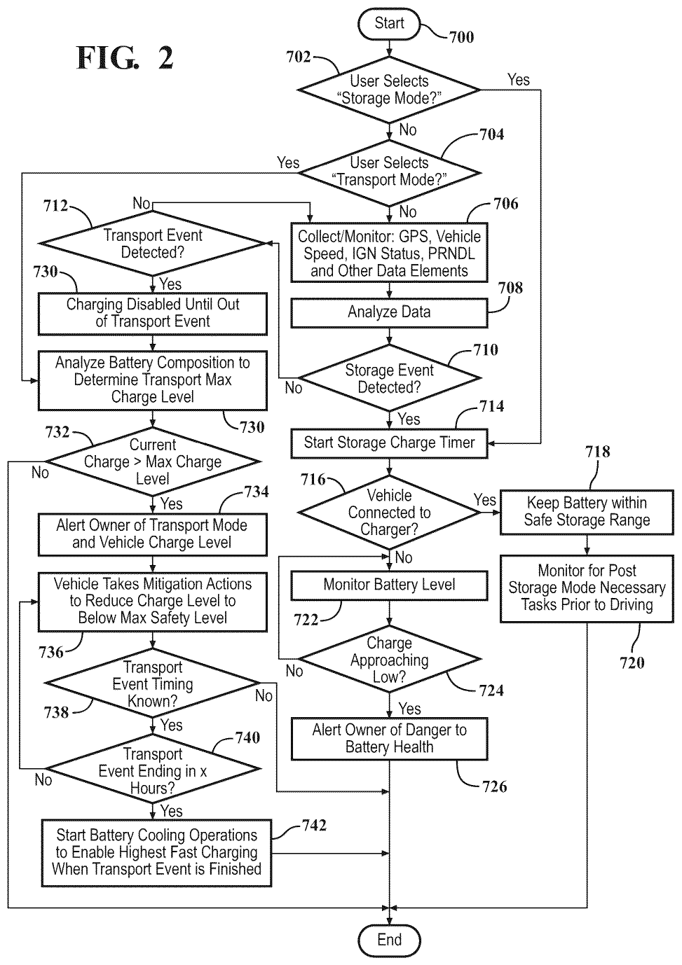

Referring now to the example shown in FIGS. 1-2, a vehicle system 100 is illustrated. The vehicle system 100 includes a vehicle processor 200 and a server 300 in communication with the vehicle processor 200. In some examples, such as the example shown in FIG. 1, the vehicle system 100 is incorporated into a vehicle 10. The vehicle 10 may be an electric vehicle 10 (EV) such that the vehicle 10 includes a battery 12 and may include autonomous or semi-autonomous capabilities. Alternatively, the vehicle 10 may be a hybrid electric vehicle (HEV) incorporating both EV and internal combustion engine (ICE) components and capabilities. While the vehicle 10 could be an EV or an HEV, the vehicle 10 will be described as incorporating only EV components and capabilities.

The vehicle processor 200 stores vehicle data 202 of the vehicle 10. The vehicle data 202 includes vehicle location 204, vehicle event data 206, vehicle mode 208, and transport length 210. The vehicle location 204 generally pertains to a location of the vehicle 10. The vehicle location 204 may include one or more of current vehicle location and route information. The current vehicle location generally pertains to the current location of the vehicle 10. The current vehicle location may be obtained from a Global Positioning System (GPS) or other navigation system and may be communicated to the vehicle processor 200. Additionally or alternatively, the current vehicle location may be obtained using vehicle cameras 14 and/or sensors 16. For example, the vehicle processor 200 may gather video data related to the current environment of the vehicle 10 to assist the vehicle processor 200 and/or the server 300 in determining the current vehicle location.

Route information generally pertains to the route the vehicle 10 is traveling, including origin and destination information. The route information may be gathered from user input, a vehicle navigation system, or past driver activity and may be communicated to the vehicle processor 200. Additionally, route information may include the route which a transport vehicle is taking. Transport vehicles may include, but are not limited to, a car carrying truck or trailer, a train, or a cargo ship. The route information also may include information related to the transport vehicle including the transport vehicle schedule and/or weather conditions that may affect travel of the transport vehicle. Further, the route information may include data related to traffic information or road closures.

The vehicle event data 206 generally pertains to actions the vehicle 10 takes. Vehicle event data 206 may be gathered by any vehicle sensors 16 and/or vehicle cameras 14 and may be communicated to the vehicle processor 200 for further processing. For example, vehicle event data 206 may include vehicle ignition status, Wi-Fi connections, vehicle speed, vehicle steering wheel angle, or other vehicle operations. More specifically, the vehicle ignition status may pertain to the current ignition status (i.e., whether the vehicle 10 is turned on or off), or may pertain to the amount of time elapsed since the last change of ignition status. Additionally, the Wi-Fi connections may relate to which Wi-Fi connections are coupled to the vehicle 10 and for how long. The vehicle speed may pertain to the current speed of the vehicle 10, whether the vehicle 10 has stopped, whether the vehicle 10 has changed speed, accelerated, or decelerated, and other vehicle speed-related events. The vehicle steering wheel angle may pertain to the current angle of the steering wheel of the vehicle 10. The angle of the steering wheel may provide information as to whether the vehicle 10 has made a turn or may be in a transport event. For example, if an angle of the steering wheel changes, this may indicate that the vehicle 10 is moving and has made a turn. In a similar fashion, if the steering wheel remains still while the location of the vehicle 10 is moving, such information may indicate that the vehicle 10 is being transported. Moreover, the vehicle event data 206 may be constantly changing such that the vehicle event data 206 may be continually sensed and/or obtained during vehicle operation.

The vehicle mode 208 generally pertains to which mode or modes of the vehicle 10 are currently operating. For example, the vehicle mode 208 may relate to any vehicle mode or operation that may affect battery life of the vehicle 10. The vehicle mode 208 may include, but is not limited to, operational modes including accessory modes, operation of individual vehicle components including vehicle engine or vehicle inverter, resistor mode, vehicle sensor modes, or other vehicle modes that require use of the battery 12. Additionally, the vehicle mode 208 may relate to a storage mode or a transport mode. The storage mode or the transport mode may be activated by a user through the vehicle dashboard or other vehicle component, through a third-party application, or through a user device such as a cellular phone or tablet. Additionally, it is contemplated that the storage mode or transport mode may be activated by the server 300, as disclosed in more detail below. Moreover, the vehicle mode 208 may be constantly changing such that the vehicle mode 208 may be continually sensed and/or obtained during vehicle operation.

The transport length 210 generally pertains to a distance or time of the transport. In some examples, the transport length 210 is inputted by a user prior to transport. However, it is also contemplated that the transport length 210 may be determined or gathered using the route information and/or destination information.

Transport companies often impose state-of-charge limitations on electric vehicles-such as the vehicle 10—prior to the vehicle 10 being allowed to be loaded onto a transport vehicle. In some examples, the state-of-charge limitation requires a vehicle battery life to be less than 60% of a full charge. In other examples, the state-of-charge limitation requires the vehicle battery life to be between 10%-55% of a full charge. In still other examples, the state-of-charge limitation requires the vehicle battery life to be between 20%-50% of a full charge. In still other examples, the state-of-charge limitation requires the vehicle battery life to be between 20%-40% of a full charge. Additionally, the state-of-charge limitation may be based on the particular chemistry of the battery 12 such that the state-of-charge limitation may be variable from vehicle to vehicle. Moreover, the state-of-charge limitation may be gathered, stored, and/or determined by the vehicle processor 200 and/or the vehicle server 300.

The vehicle processor 200 is also configured to store vehicle battery life information. The vehicle battery life information generally pertains to the amount of vehicle battery life the battery 12 has remaining. Additionally, the vehicle battery life information may be affected by one or more of the vehicle event data 206, the vehicle mode 208, the vehicle location 204, and the transport length 210. Moreover, the vehicle battery life information may include whether the vehicle 10 is within the state-of-charge limitation that may be implemented by the transport vehicle along the route. For example, the vehicle battery life information may include whether the vehicle battery life is within the acceptable charge limit of a particular transport vehicle.

With further reference to FIGS. 1 and 2, the server 300 is configured as a network and/or a cloud-based system that communicates with the vehicle processor 200. It is also contemplated that the vehicle processor 200 may communicate any or all of the vehicle data 202 to the server 300 for further processing and/or evaluation. Further, the vehicle processor 200 and/or the server 300 may continuously and/or regularly update such that the vehicle data 202 is updated in real time.

The server 300 may also be configured to communicate with third-party processors 500 to collect third-party data. For example, the third-party processors 500 may include, but are not limited to, vehicle processors 200 along the route. Additionally or alternatively, the third-party processors 500 may include third-party user devices within vehicles along the route such as, for example, cellular phones and/or tablets. Further, the third-party processors 500 may include third-party databases such as databases including transport vehicle schedules, weather information, and/or traffic conditions. It is generally contemplated that the third-party data may include information related to one or more of the vehicle location 204, the vehicle event data 206, the vehicle mode 208, and/or the transport length 210 from the third-party processors 500.

Referring still to the example shown in FIGS. 1 and 2, the server 300 is configured to determine when the vehicle 10 is being stored based on the vehicle location 204 and the vehicle event data 206. More specifically, the server 300 may use data collected from the vehicle processor 200 such as GPS data, vehicle camera data, vehicle ignition status, and/or time since last vehicle ignition status change to determine if the vehicle 10 is being stored. For example, if the vehicle 10 has been at the same GPS location for a predetermined amount of time, which can be confirmed by data from the vehicle camera(s) 14, and has not changed the ignition status in the predetermined amount of time, the server 300 may determine that the vehicle 10 is being stored. In other examples, the vehicle camera(s) 14 may be able to detect a vehicle cover or other indicators that help the server 300 determine that the vehicle 10 may be being stored. In other examples, the vehicle event data 206 may indicate that the vehicle 10 has been connected to the same Wi-Fi connection for a predetermined period of time.

Additionally, if the server 300 determines that the vehicle 10 is being stored, the server 300 may activate the storage mode. The storage mode may include activation of additional features including, but not limited to, monitoring vehicle battery life and setting up a low battery power timer. Monitoring vehicle battery life may include keeping the battery life low enough to reduce the risk of a fire while setting up a low battery power timer may be used to instruct a vehicle owner or user to charge the battery 12 to prevent the vehicle battery life from getting too low and causing damage to the battery 12. As such, activating the storage mode may activate vehicle charging while in the storage mode if the vehicle 10 is connected to a charger. However, while the vehicle 10 may be charged while in the storage mode, the server 300 will be configured to keep the vehicle battery life within the state-of-charge limitations. Additionally, the server 300 may be configured to notify an owner or user of the storage mode being activated and/or if the battery 12 reaches a predetermined low vehicle battery life (i.e., near zero charge).

Additionally, when the storage mode is deactivated, either by a user ending storage mode manually, or by changing the ignition status (i.e., turning the vehicle on) the server 300 is configured to check for post storage mode tasks that might need to be done prior to driving. The storage mode tasks may include, but are not limited to, checking if the vehicle 10 requires an oil change, fuel level and age, tire rotation status, tire pressure monitoring, and windshield fluid check. Additionally, the server 300 may be configured to notify the user of any post storage mode tasks that need attention. For example, if the server 300 activates storage mode, the server 300 will monitor the vehicle battery life and, if connected to a vehicle charger, the server 300 will keep the vehicle battery life within the state-of-charge limitations. Additionally, when a user wants to use the vehicle 10 again, the user may turn on the vehicle 10, which will prompt the server 300 to deactivate the storage mode and notify the user of post storage tasks that need attention. For example, if the tires are low on air pressure, the server 300 will send a notification to a user device such as a cellular phone or table and/or to the vehicle dashboard to alert the user to put more air in the tires as soon as possible.

The server 300 is also configured to determine if the vehicle 10 is being transported based on the vehicle location 204 and the vehicle data 202. For example, if the server 300 detects that the vehicle 10 is changing location based on the GPS location but the vehicle 10 is not on or has no vehicle speed, the server 300 may determine that the vehicle 10 is being transported. Additionally, the server 300 may also be configured to notify the user that the vehicle 10 is currently being transported. As such, if the server 300 determines that the vehicle is being transported and the server 300 notifies the user of the transport, the user can prepare for vehicle delivery or have knowledge that the vehicle 10 is currently being towed.

Additionally, if the server 300 determines that the vehicle is being transported, the server 300 may be configured to activate the transport mode. In the transport mode, the server 300 is configured to monitor the vehicle battery life and compare it with the maximum state-of-charge limitation of the transport vehicle. If the current vehicle battery life is greater than the maximum state-of-charge limitation, the server 300 may be configured to alert the user of the situation, to limit charging capability if the vehicle 10 is coupled to a charging station, and/or begin energy reduction activities. Additionally, the server 300 may be configured to notify the user of potentially dangerous low vehicle battery life during transport mode. The notification may be through a third-party application, a user device, the vehicle dashboard, or other vehicle systems. Moreover, the server 300 may be configured to pre-condition a temperature of the battery 12 to allow for faster charging after the transport mode has completed. The server 300 may be configured to use route information such as vehicle destination information or user input to determine when the pre-conditioning should occur. For example, during a winter transport in a cold climate, the server 300 may be configured to heat up the battery 12 during the transport mode to allow for faster charging upon arrival at the destination.

Additionally, the server 300 may be configured to start battery depletion activities based on the vehicle location 204, the vehicle event data 206, and the transport length 210. For example, if the transport length 210 is known, the server 300 may use the current vehicle location 204 and the vehicle event data 206 to determine how much battery depletion is required and for how long battery depletion activities should be deployed. Additionally, once the transport mode has been activated, the server 300 will check the current battery life and determine whether it is within the state-of-charge limitation for transporting on the particular transport vehicle. If the server 300 determines that the current battery life is above the state-of-charge limitation for transporting, the server 300 will immediately block any further charging activities and begin battery depletion activities.

The battery depletion activities may include one or more of enabling max accessory loads including one or more of a chiller operation increase or an increase in coolant flow rate, additional vehicle imaging, activating vehicle sensors to a high-load mode, activating discharge of cell groups by activating cell balancing resistors, and activating inefficient operation of vehicle components including one or more of the vehicle engine or vehicle inverter. Additionally, the server 300 may be configured to determine which battery depleting activities to activate based on the vehicle location 204, the vehicle data 202, and the transport length 210, as not all battery depletion activities may operate simultaneously. Moreover, it is contemplated that battery depletion activities may continue until the server 300 determines the current battery life is within the state-of-charge limitation for transporting. For example, if the server 300 determines that activating inefficient operation of the vehicle engine should be activated, the server 300 may continue to run the inefficient operation of the vehicle engine until the current vehicle battery life is within the state-of-charge limitation.

Additionally, the server 300 may block charging of a vehicle if an upcoming transport event is known. For example, if a user has indicated that the vehicle 10 will be transported the next day and begins charging the vehicle 10, the server 300 may block charging of the vehicle 10 completely or may only allow charge to a certain vehicle battery life such that the battery 12 will still comply with the state-of-charge limitations during the transport the next day.

Referring now to the example shown in FIG. 2, the vehicle system 100 begins operation at step 700. In step 702, the server 300 determines whether the user has selected the storage mode. If the user has not selected the storage mode, the server 300 determines whether the user has selected the transport mode at step 704. If the user has not selected the transport mode, the vehicle 10 collects vehicle data 202 at step 706. The vehicle data 202 is then analyzed by the server 300 at step 708 to determine whether a storage event is detected at step 710. If a storage event is not detected, the server 300 will determine whether a transport event is detected at step 712. However, if a storage event is detected by either the user selecting the storage mode at step 702 or the server 300 determining the vehicle 10 is being stored at step 710, the vehicle system 100 will start a storage charge timer to determine how much time is available in the battery life at step 714. The server 300 then determines if the vehicle 10 is connected to a charger at step 716. If the vehicle 10 is connected to the charger, the server 300 is configured to keep the battery 12 within the safe storage range at step 718. Additionally, the server 300 is configured to monitor for post-storage mode tasks which may be necessary prior to driving at step 720. If the vehicle 10 is not connected to the charger, the server 300 is configured to monitor the vehicle battery life at step 722 and determine if the battery 12 is approaching low vehicle battery life at step 724. If the battery 12 is approaching low vehicle battery life, the user is alerted to the low battery and potential dangers at step 726.

Additionally, if a user selects transport mode at step 704 or if a transport event is detected at step 712, the server 300 is configured to disable charging until the vehicle 10 is out of the transport mode at step 728. Additionally, the server 300 is configured to analyze the composition of the battery 12 to determine the state-of-charge limitation at step 730. Next, the server 300 is configured to determine whether the current vehicle battery life is greater than the determined state-of-charge limitation at step 732. If the current vehicle battery life is greater than the determined state-of-charge limitation, the server 300 is configured to alert the user that a transport is in progress and of the current vehicle battery life at step 734. The server 300 is also configured to take mitigation actions to reduce the vehicle battery life below the state-of-charge limitation at step 736. If the timing of the transport event is not known at step 738, once the mitigation actions reduce the vehicle battery life below the state-of-charge limitation, the program ends. However, if the timing of the transport event is known at step 738, the server 300 determines when the transport event is ending in a predetermined amount of time at step 740 and starts battery temperature operations to enable fast charging when the transport event is finished at step 742.

Many vehicles are now electric vehicles powered using batteries. Batteries, particularly fully charged batteries, pose a potential fire risk under certain conditions. As such, it is often advantageous to provide electric vehicles being transported or stored with a charge below the maximum charge safety level to mitigate any fire risks. The vehicle system 100 as described herein provides a user-friendly way to safely and easily store and/or transport the vehicle 10 while complying with state-of-charge limitations.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle system for a vehicle, the vehicle system comprising:
a vehicle processor for storing vehicle data including vehicle location and vehicle event data; and
a server communicatively coupled to the vehicle processor and configured to:
determine when the vehicle is being stored based on the vehicle location and the vehicle event data; and
activate a storage mode when it is determined that the vehicle is being stored.

2. The vehicle system of claim 1, wherein the server is configured to notify a user of storage mode being activated.

3. The vehicle system of claim 1, wherein the server is configured to monitor vehicle battery life during the storage mode.

4. The vehicle system of claim 3, wherein the server is configured to notify a user of low vehicle battery life during the storage mode.

5. The vehicle system of claim 1, wherein the server is configured to check for post storage mode tasks that might need to be done prior to driving.

6. The vehicle system of claim 5, wherein the server is configured to notify a user of post storage mode tasks.

7. A vehicle incorporating the vehicle system of claim 1.

8. A vehicle system for a vehicle, the vehicle system comprising:
a vehicle processor for storing vehicle data including vehicle location and vehicle event data; and
a server communicatively coupled to the vehicle processor and configured to:
determine when the vehicle is being transported based on the vehicle location and the vehicle event data; and
activate a transport mode when it is determined that the vehicle is being transported.

9. The vehicle system of claim 8, wherein the vehicle location includes Global Positioning System (GPS) location and route information.

10. The vehicle system of claim 8, wherein the server is configured to notify a user if it is determined that the vehicle is being transported.

11. The vehicle system of claim 8, wherein the server is configured to monitor vehicle battery life during the transport mode.

12. The vehicle system of claim 11, wherein the server is configured to notify a user of low vehicle battery life during the transport mode.

13. The vehicle system of claim 8, wherein the server is configured to pre-condition a temperature of a vehicle battery to allow for faster charging after the transport mode has completed.

14. A vehicle incorporating the vehicle system of claim 8.

15. A vehicle system for a vehicle, the vehicle system comprising:
a vehicle processor for storing vehicle data including vehicle location, vehicle event data, and transport length; and
a server communicatively coupled to the vehicle processor and configured to:
activate battery depletion activities based on the vehicle location, the vehicle event data, and the transport length, wherein the battery depletion activities include one or more of enabling max accessory loads including one or more of a chiller operation increase or an increase in coolant flow rate, additional vehicle imaging, activating vehicle sensors to a high-load mode, activating discharge of cell groups by activating cell balancing resistors, and activating inefficient operation of vehicle components including one or more of a vehicle engine or a vehicle inverter; and
determine which battery depleting activities to activate based on the vehicle location, the vehicle event data, and the transport length.

16. The vehicle system of claim 15, wherein the vehicle location includes GPS location and route information.

17. The vehicle system of claim 15, wherein the server is configured to notify the user if it is determined that the vehicle is being transported.

18. The vehicle system of claim 17, wherein the server is configured to monitor vehicle battery life if it is determined that the vehicle is being transported.

19. The vehicle system of claim 17, wherein the server is configured to pre-condition a temperature of a vehicle battery following vehicle transport.

20. A vehicle incorporating the vehicle system of claim 15.
